(19) United States
(12) Patent Application Publication
(10) Pub. No.: US 2016/0048504 A1
(43) Pub. Date: Feb. 18, 2016

(54) CONVERSION OF INTERLINGUA INTO ANY NATURAL LANGUAGE

(71) Applicant: AVAZ, INC., Palo Alto, CA (US)

(72) Inventor: Ajit Narayanan, Chennai (IN)

(21) Appl. No.: 14/827,203

(22) Filed: Aug. 14, 2015

(30) Foreign Application Priority Data
Aug. 14, 2014 (IN) 3990/CHE/2014

(51) Int. Cl. G06F 17/28

(52) U.S. Cl. CPC G06F 17/28

(57) ABSTRACT

The embodiments herein achieve a natural language generation system and mechanisms for converting an interlingua into any set of natural languages. The system is capable of converting a large class of generic, semantically-oriented interlingua into any natural language. The system may be incorporated on PCs, mobile devices or may be an application running on a remote system which allows for language-independent messages to be constructed, which can be de-constructed into any language on the receiver's side. Mechanisms of implementation would also be of assistance in allowing people with speech, communication or language disabilities, language difficulties, language-independent or precise human-human or human-machine communication to communicate effectively.

This application claims the benefit of India Provisional Application No. 3990/CHE/2014, filed Aug. 14, 2014.

### TECHNICAL FIELD

This invention relates to language conversion systems, and more particularly to a method for converting an interlingua to natural language.

### BACKGROUND

Natural language (NL) and its use are daily matters for every human being. Linguistics, the study of NL, is a well-established discipline. Machine translation (MT), the use of computer to translate texts between NLs, has been researched from decades soon after the birth of computer. Augmentative and alternative communication (AAC), the use of computer to communicate, has also been researched for several decades.

Right after the start of MT research, proposals and discussions were made for an interlingua method (IM) of MT. An interlingua is an artificial language that usually acts as an intermediary language in machine translation—where, instead of translating one language to another directly, a translation is first done to the intermediary language and then from the intermediary language to the target language. An interlingua usually attempts to capture meaning or semantic information, and such an interlingua is called a semantic interlingua. For a brief discussion of a picture-based semantic interlingua, reference is made to U.S. Pat. No. 8,712,780 to Ajit Narayanan. (Dec. 8, 2010), entitled “Systems and methods for picture based communication”.

As a picture-based interlingua is arguably easier to learn and manipulate than the NLs for persons who do not know the NL fluently, and as the interlingua can be converted technically into the NL, many different systems and methods are proposed to convert the interlingua into the NL. These find applications in language learning and in AAC. Current approaches to NL conversion involve statistical and linguistic analyses to select meanings from information repositories. Despite the great advance in linguistics, a lexicon and a grammar applicable for all NLs have not been found. Further, the information repositories are typically deduced from the source language text. These information repositories are used to generate information repositories for the target language which in turn are used to produce a set of candidate NL translations.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram illustrating various modules of an electronic device, according to embodiments herein;

FIG. 2A illustrates an example semantic graph (without sub-graphs), according to embodiments herein;

FIG. 2B illustrates an example semantic graph (with sub-graphs), according to embodiments herein;

FIG. 3 is a flow chart illustrating a method for natural language communication based on conversion of a semantic interlingua into a target language, according to embodiments herein;

FIG. 4A is a flow chart illustrating a method for transforming a picture based interlingua into a sentence in a target language, according to embodiments herein;

FIG. 4B is a flowchart illustrating a method for creating a graph data structure out of the textual representation of the semantic interlingua, according to embodiments herein;

FIG. 4C is a flowchart illustrating a method for removing cycles and back-references from the graph data structure by resolving pronouns and relative clauses, according to embodiments herein;

FIG. 4D is a flowchart illustrating a method for breaking an edge having a start node, an end node, and a relation, according to embodiments herein;

FIG. 4E is a flowchart illustrating a method for creating the x tree depends on the kind of node it is, according to embodiments herein;

FIG. 4F is a flowchart illustrating a method for creating a Complementarizer Projection (CP) for a full sentence, according to embodiments herein;

FIG. 4G is a flowchart illustrating a method 400g for creating a CP for a relative clause, according to embodiments herein;

FIG. 5A shows an example of a sentence where a pronoun is inferred, according to embodiments herein;

FIG. 5B shows an example of a sentence where a relative clause is introduced, according to embodiments herein;

FIGS. 6A-6H shows examples of various movements, according to embodiments herein; and

FIG. 7 depicts a computing environment implementing the method and system as described herein, according to embodiments herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a system and a computerized method for conversion of interlingua to a natural language (NL) through application of various rules. The rules can be specific to the target NL, and are applied through a cascade of rule engines.

An interlingua is an artificial language that can act as an intermediary language in machine translation, whereby, instead of translating one language to another directly, a translation is first done to the intermediary language and then from the intermediary language to the target language. Interlingua are also used in augmentative and alternative communication (AAC) where people who have difficulties communicating in particular languages or using natural speech use a computer to communicate. In many applications of AAC, the users are persons with disabilities. For a subset of these individuals, the inability to communicate is a result of impairment in language processing, and the use of a picture-based communication system to communicate results in higher communication function. A picture based semantic interlingua is a way for AAC users to communicate in pictures with similar expressive capability as communicating with words.

The interlingua used herein includes four different components, which are strung together to create a sentence. The components are:
1 Word senses: A word sense represents a unique meaning associated with a word. This is assigned a unique identifier which is read from a dictionary. When applied to picture-based communication, a word sense is associated with a picture.
2 Relations: Relations establish a unique, one-to-one relationship between two words, and are directional in nature.
3 Attributes: Attributes associated with a word reflect shades of a meaning associated with the word like tense, aspect, modality, number, gender, and the like.
4 Sub-graphs: Sub-graphs represent groups of words such as phrases and clauses which act as a single word. A sub-graph is also known as and referred to as a scope.

The interlingua can be represented as a hyper-graph, with words forming nodes, being annotated by attributes, and edges being relations. Sub-graphs contain their own internal nodes with attributes and relations. Pronouns are all represented with the generic word “PRO (00)”. This is true for all personal, interrogative and relative pronouns. And all non-polar questions are represented with the generic question pronoun “Q (00.@wh)”.

In an embodiment, the semantic interlingua format used is Universal Networking language (UNL).

The method for conversion of interlingua to NL disclosed herein includes generating, by a control module, a graph data structure of a semantic interlingua using at least one graph rule from a rule engine. Further, the method includes removal, by the controller module, of cycles and loops in the graph by inferring pronouns and relative clauses. Further, the method includes generating, by the control module, a tree data structure based on an analysis of the graph data structure, using at least one graph-to-tree conversion rule from the rule engine. Furthermore, the method includes transforming, by a sequence converter, the tree data structure into a sentence of target language, where the tree data structure is transformed based on at least one sequence transformation rule from the rule engine.

In a preferred embodiment, the graph data structure described herein includes a plurality of graph nodes indicating at least one of a word with an annotation, a set of attributes, a special identifier marking a sub-graph, and a list of edges. Each graph node is associated with a dictionary entry, where the dictionary includes at least one of root form of the word, morphological properties, parts of speech, and framing structure. The set of attributes associated with each graph node in the graph data structure defines a semantic transformation of the graph node, using which the set of attributes associated with each graph node can be normalized based on at least one attribute rule. The plurality of nodes include an entry node for each sub-graph and for the entire graph, representing a head of the sentence or clause.

In an embodiment, generation of the graph data structure of the interlingua includes enumerating all sub-graphs, creating an empty graph for each the sub-graph, converting each node of an edge into a unique node when either endpoints are pronouns, creating a map for mapping node identifiers to each the node; setting an entry point as a sub-graph when the entry point of the graph is explicitly specified; and adding the edge as a relation to the at least two nodes.

In a preferred embodiment, the tree data structure includes an xtree structure representing a syntactic structure, the xtree structure including at least one of a maximal projection node, an intermediate projection node, a head node, pointers, and properties for the tree data structure. Each tree node is associated with at least one of a label representing a word position in the tree data structure, a pointer to define the tree data structure, a link to the tree data structure to which the tree node belongs, and morphological properties of a word.

In various embodiments, removal of loops and cycles from the graph based on the analysis of the graph data structure includes traversing the graph data structure node-by-node, the graph data structure being traversed from an entry node and proceeding outwards along edges; selecting an edge to break to remove loops and cycles from the graph data structure; and breaking edge having a start node, an end node, and a relation. In an embodiment, the conditions for selecting an edge to break the graph data structure includes checking if an entry node has an incoming edge, or if a non-entry node has more than one incoming edge, or if a circular loop is detected in the graph. In an embodiment, the breaking of at least one edge (having a start node, an end node and a relation) includes removing the relation from the graph data structure; duplicating the end node of the edge; making the duplicate node a pronoun; connecting the duplicate node to the start node; and determining whether resulting graph data structure is connected or broken into two fragments by the edge-breaking.

Furthermore, the method includes communicating the sentence of target language to a party by a user interface module, the target language is based on an input representing mode of communication. In an embodiment, the mode of communication is at least one of an audio, a visual, and an audio visual formats.

The proposed system and method can be used in any conversion system for converting an interlingua (visual or intermediate language) into any set of natural languages. Unlike the conventional systems and methods, the proposed conversion system and method is capable of converting a large class of generic, semantically-oriented interlingua into any natural language. The interlingua is arguably easier to learn and manipulate than natural languages; and it can be converted technically into any natural language. Such an interlingua, along with the conversion technique, finds use in a number of applications. These applications include second language teaching to persons with speech, communication, or language disabilities, language difficulties, language-independent, or precise human-human or human-machine communication, dyslexia or illiteracy, to communicate effectively. Further, the proposed method may be incorporated on PCs, mobile devices or may be an application running on a remote system which allows for language-independent messages to be constructed, which can be de-constructed into any language on the receiver's side.

Thus, advantages of one or more aspects of Interlingua approach and its conversion to natural language are well-known. Other advantages of one or more aspects will become apparent from a consideration of the ensuing description and accompanying figures.

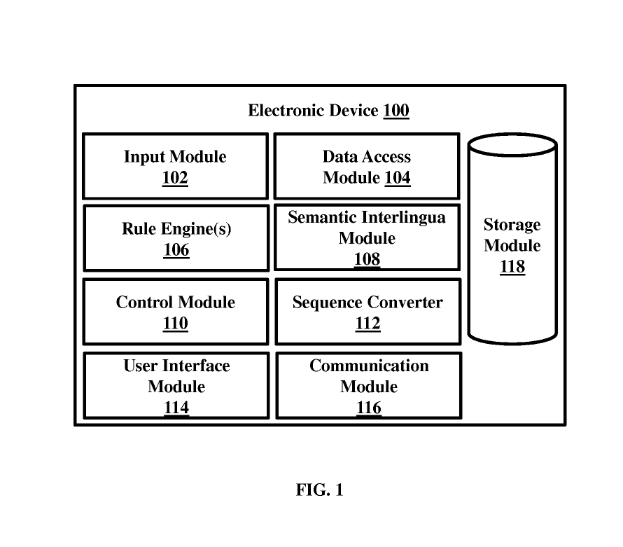

Referring now to the drawings, and more particularly to FIGS. 1 through 7, where similar reference characters denote corresponding features consistently throughout the figures, there are shown preferred embodiments. More specifically, the system and computerized-methods for conversion of interlingua to NL using the various rules through the cascade of rules engines are illustrated using example embodiments.

FIG. 1 is a block diagram illustrating various modules of an electronic device 100, according to embodiments as described herein. In an embodiment, the electronic device 100 can be for example, but is not limited to, a personal computer, a laptop, a personal digital assistance, a communicator, a server, a tablet, a phablet, or the like. The electronic device 100 described herein reflects a conversion system capable of converting a large class of generic, semantically-oriented interlingua into any natural language locally or remotely using an application running on a remote system which allows for language-independent messages to be constructed and de-constructed into any language on the receiver's side.

In an embodiment, the electronic device 100 can be configured to include an input module 102, a data access module 104, one or more rule engines 106, a semantic interlingua module 108, a control module 110, a sequence converter module 112, a user interface module 114, a communication module 116, and a storage module 118.

The input module 102 is configured to provide input to the system. For the sake of simplicity, the various example embodiments herein assume that the input is a single sentence. However, as would be appreciated by an ordinary person skilled in the art, the system is not limited to a single sentence input.

In an embodiment, the input module may be configured to construct an input sentence based on touch input received in the form of a set of pictures selected by a user using the electronic device 100. A semantic interlingua module 108 may then provide an interlingua for the constructed input sentence. The semantic interlingua module 108 can be configured to provide the interlingua corresponding to an input (a sentence, for example) for further conversion. For a brief discussion of a picture-based semantic interlingua, reference is made to U.S. Pat. No. 8,712,780 to Ajit Narayanan. (Dec. 8, 2010), entitled “Systems and methods for picture based communication”.

The data access module 104 provides access to the data stored in the storage module 118. The data access module 104 performs marshalling and un-marshalling of data in specific data structure formats as required by various other modules of the device 100.

In a preferred embodiment, there are three different data structures that are used in the conversion system:
1 The structure of interlingua, representing the semantic meaning of the sentence (hereinafter referred to as “G” for graph).
2 An internal representation (hereinafter referred to as “X” for xtree) representing the syntactic structure of the sentence of the target language to which the interlingua is converted.
3 A sequence of words in the target language (hereinafter referred to as “S” for sequence).

In a preferred embodiment, G is a graph-language representation called Universal Networking Language (UNL), the data-structure X is a tree, and the data-structure S is a list of words in the target language.

Further, the rule engine(s) 106 can be configured to apply a set of rules that allow transformations from G to G, G to X, X to X, X to S, and S to S. After application of the various rules of transformation, the final S that results is the sequence of words that represents the output sentence.

In a preferred embodiment, the rules are modeled as pattern-matching, and substitution rules. The rules typically have a pattern which is looked-for in the input, and if the pattern matches, a certain transformation is specified in the rule.

The control module 110 can be configured to control the overall conversion mechanism. The control module 110 can provide instructions to convert a large class of generic, semantically-oriented interlingua into any natural language. The control module 110 can be configured to generate a graph data structure of the interlingua provided by the semantic interlingua module 108 using one or more graph rules from one or more rule engines that are part of the rule engine module 106.

The graph data structure disclosed herein can include a plurality of graph nodes indicating at least one of a word with an annotation, a set of attributes, a list of edges, and the like. The graph nodes include an entry node representing a head of the sentence or clause. Each graph node in the graph data structure can be associated with a dictionary including a root form of the word, morphological properties, parts of speech, framing structure, and the like. The set of attributes associated with each graph node in the graph data structure defines a semantic transformation of the graph node. The set of attributes associated with each graph node is normalized based on one or more attribute rules applied by one or more rule engines of the rule engine module 106.

The control module 110 can be configured to generate a tree data structure based on analysis of the graph data structure. In an embodiment, the graph data structure is analyzed based on one or more semantic rules generated by the rule engine module 106. The rule engine module 106 can be configured to define the one or more semantic rules using an edge pattern, a two node pattern, an output pattern, an output variable, or the like.

In an embodiment, the tree data structure described herein can include a specific type of tree, referred to here as xtree structure, representing a syntactic structure. The xtree structure can include a maximal projection (MP) node, an intermediate projection (IP) node, a head (H) node, or the like. Each tree node can be associated with a label representing a word position in the tree data structure, a pointer to define the tree data structure, a link to the tree data structure to which the tree node belongs, morphological properties of a word, or the like.

The sequence converter module 112 can be configured to transform the tree data structure into a sentence of a target language. The converter 112 may apply a sequence of transformations based on rules in generating a sentence in the target language, including but not limited to movement rules to transform the tree structure based on patterns in the tree structure, morphology rules to transform the tree with leaves of word-nodes associated with attributes into a linear structure of actual words, and sequence transformation rules to operate on the words in the linear structure, to generate a sequence of words that can be used to form a sentence.

In a preferred embodiment, the control module 110 is further configured to perform sentence extraction to generate the final sentence in a user readable format based on the sequence of words generated by the sequence converter module 112.

The user interface module 114 can be configured to communicate the final user readable sentence in the target language to a receiving party or user. The mode of output enabled by the user interface to user of the electronic device 100 is can be, but is not limited to, at least one of an audio, a visual, and an audio visual.

The target language can be configured based on user selection. In other embodiments target language can be pre-configured to a specific language.

Further, the communication module 116 can be configured to allow communication between various modules within the device 100. The communication module 116 can be configured to implement necessary interfaces to enable communication and data transfer with external devices including interfaces for but not limited to Wide Area Network (WAN), Local Area Network (LAN), cellular network, satellite network (for example, to enable GPS communication), WiFi, WiMAX, Bluetooth, USB, and Ethernet.

The storage module 118 can be configured to store data and instructions to perform various operations as described herein, including rules for various rule engines.

In an embodiment, the storage module 118 can include a database, where the database is an internal database tightly coupled to the application components. In other embodiments, the database can be an independent service running on a same computing machine, or a different machine being accessible over a network using the interfaces provided by the communication module 116. The database may be a relational SQL database, Operational Database, text database or No-SQL database and/or combination thereof. In some embodiments database may be a single instance running on a single machine. In some other embodiments, the storage module 118 may host a single instance from a cluster of databases running in multiple locations, each updating each other using a master-slave configuration or otherwise.

In an embodiment, the storage module 118 may use the file system of the electronic device 100 to provide storage functionality to the various modules.

Although the FIG. 1 shows a limited overview of various modules of the electronic device incorporating the conversion system but, it is to be understood that other embodiments are not limited thereon. The various modules are only one example of a suitable environment and are not intended to suggest any limitation as to the scope of use or functionality of the invention. Further, the conversion system can include different modules communicating among each other locally or remotely along with a combination of hardware and software components. For example, a component can be, but not limited to, a process running in the master or slave device, an executable process, a thread of execution, a program, or a computer.

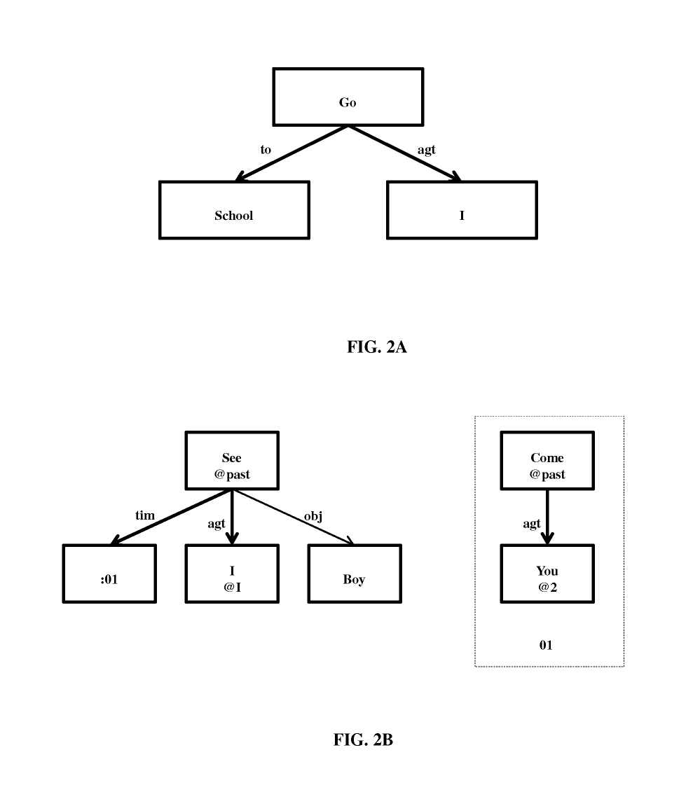

FIG. 2A illustrates an example semantic graph (without sub-graphs), according to embodiments as disclosed herein. Typically, all sentences, however complex, can be decomposed as a cascading set of answers to a set of questions. This generates a data structure that looks like a tree or graph; however, it is not strictly a tree or graph, since the data structure may contain back-references, sub-graphs, and inter-links. An example semantic graph without sub-graphs is shown in the FIG. 2A. The graph represents a sentence “I go to school”. The relation ‘agt’ represents the question ‘who’. The relation ‘to’ represents the question ‘where to’.

FIG. 2B illustrates an example semantic graph (with sub-graphs), according to embodiments as disclosed herein. The graph represents a sentence “I saw the boy when you came”. The relation ‘tim’ represents the question ‘when’.

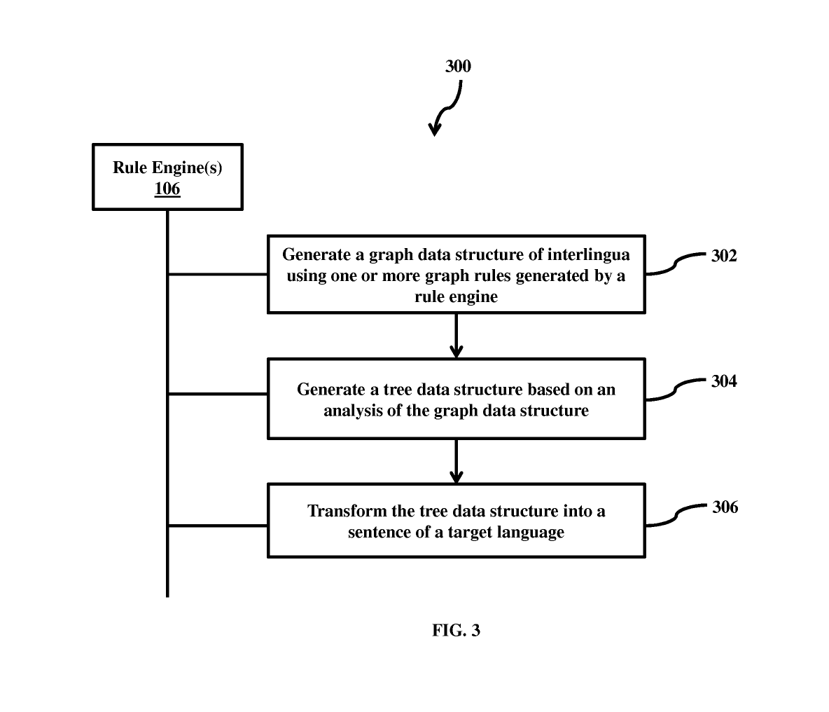

FIG. 3 is a flow chart illustrating a method 300 for conversion of an interlingua into a target language, according to embodiments herein. The method 300 and other embodiments herein provide a basis for a control program which can readily be implemented using a microcontroller, microprocessor, or a combination thereof.

In an embodiment, at step 302, the method 300 includes generating, by the control module 110, a graph data structure of the picture based semantic interlingua using one or more graph rules applied by the rule engine 106. The graph data structure can include a plurality of graph nodes indicating at least one of a word sense with an annotation, a set of attributes, a list of edges, and the like. The set of attributes associated with each graph node in the graph data structure defines a specific semantic transformation of the graph node. The set of attributes associated with each graph node is normalized based on one or more attribute rules applied by the rule engine 106.

At step 304, the method 300 includes generating, by the control module 110, a tree data structure based on an analysis of the graph data structure. The method 300 allows the control module to analyze the graph data structure based on one or more graph-to-tree conversion rules applied by the rule engine 106. The method 300 allows the rule engine 106 to define the one or more graph-to-tree rules using an edge pattern, a two node pattern, an output pattern, an output variable, or the like.

In an embodiment, the tree data structure described can include an xtree structure representing a syntactic structure. The xtree structure can include a maximal projection node, an intermediate projection node, a head node, or the like. Each tree node can be associated with a label representing a word position in the tree data structure, a pointer to define the tree data structure, a link to the tree data structure to which the tree node belongs, morphological properties of a word, or the like.

At step 306, the method 300 includes transforming, by the sequence converter module 112, the tree data structure into a sentence of target language. The method 300 allows the sequence converter module 112 to use one or more sequence transformation rules generated by the rule engine 106 to transform the tree data structure into a sentence of target language. A sequence of words representing the sentence based on the tree data structure is generated. The method 300 allows the sequence converter module 112 to use one or more movement rules generated by the rule engine 106 to generate an intermediate structure with leaves with word-nodes. Further, the method 300 provides for a morphology transformation of the intermediate structure with word-nodes to a linear structure of words by the sequence converter module 112. Furthermore, the method 300 allows the sequence converter module 112 to convert the sequence of words into a sentence of target language using one or more sequence transformation rules, wherein the sequence transformation rule operates on a list of words. A sentence extraction step may further be performed to generate a user readable format of sentence in target language. The user interface module 114 communicates the sentence of target language to a receiving party or user. The target language is based on an input representing mode of communication such as for example, but is not limited to, mode of communication is at least one of an audio, a visual, and an audio visual.

The various actions, acts, blocks, steps, and the like in method 300 may be performed in the order presented, in a different order or simultaneously. Further, in some embodiments, some actions, acts, blocks, steps, and the like may be omitted, added, modified, skipped, and the like without departing from the scope of the invention.

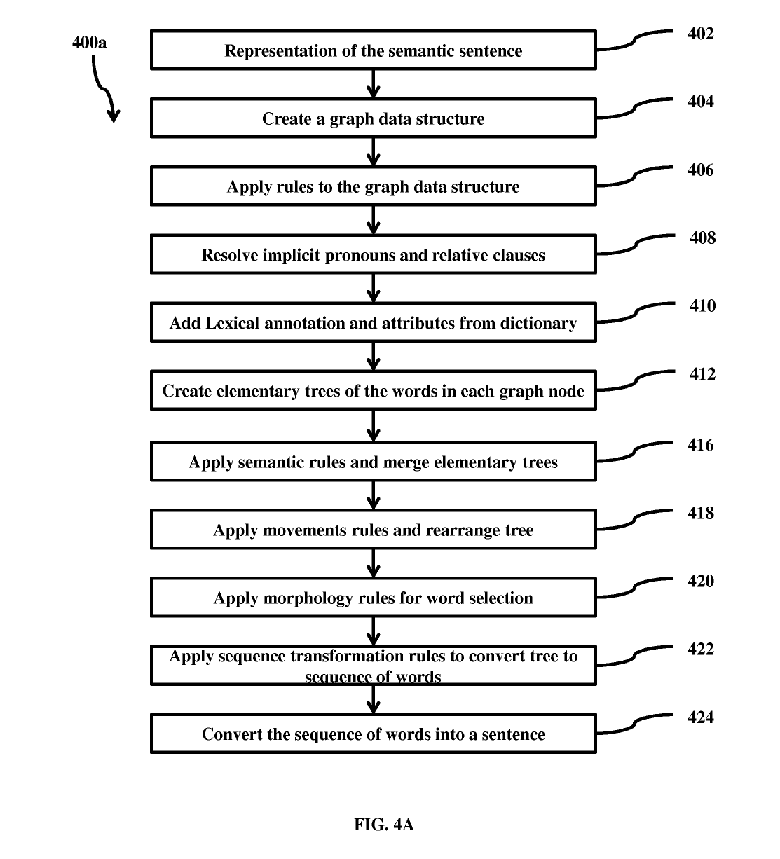

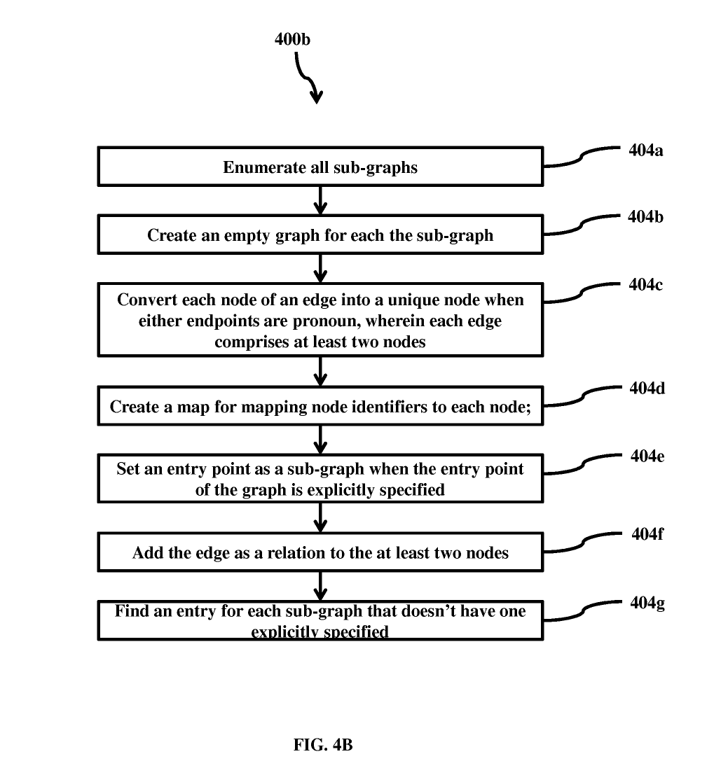

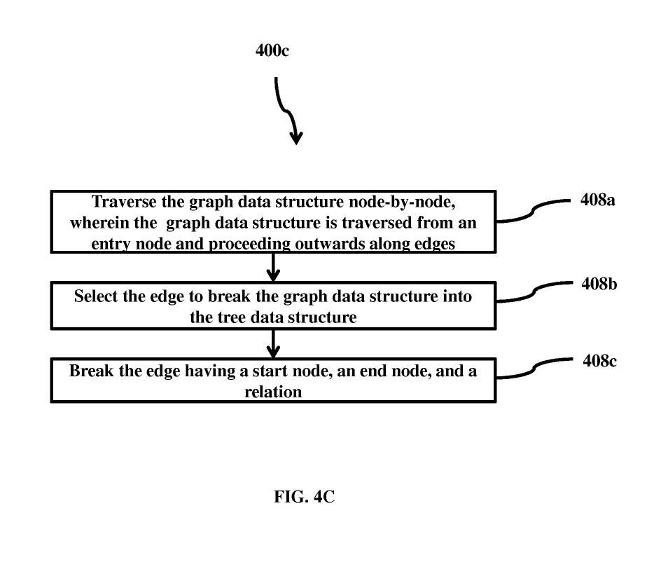

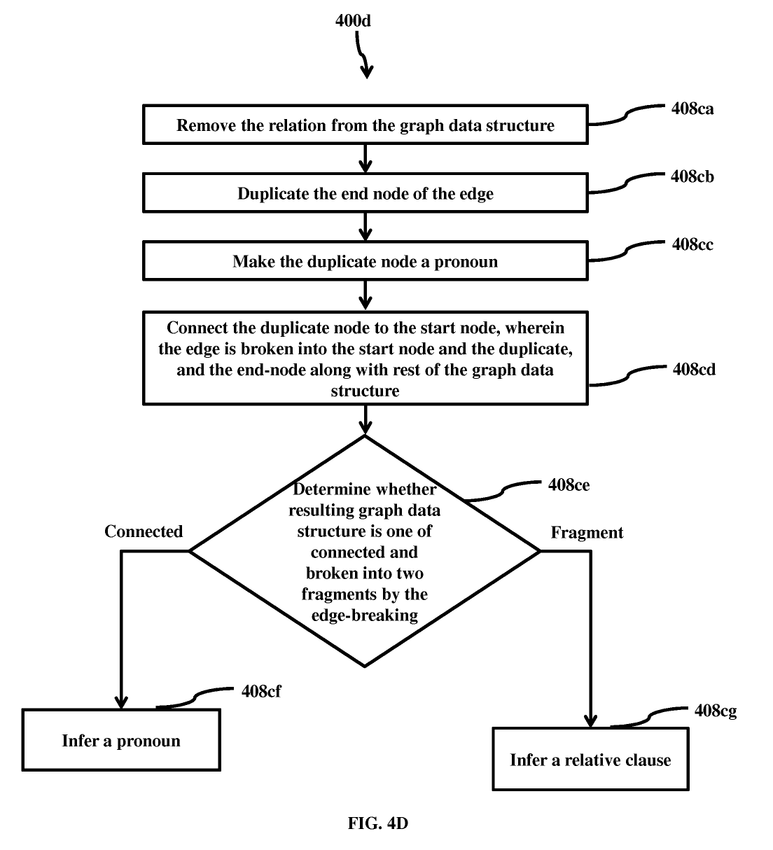

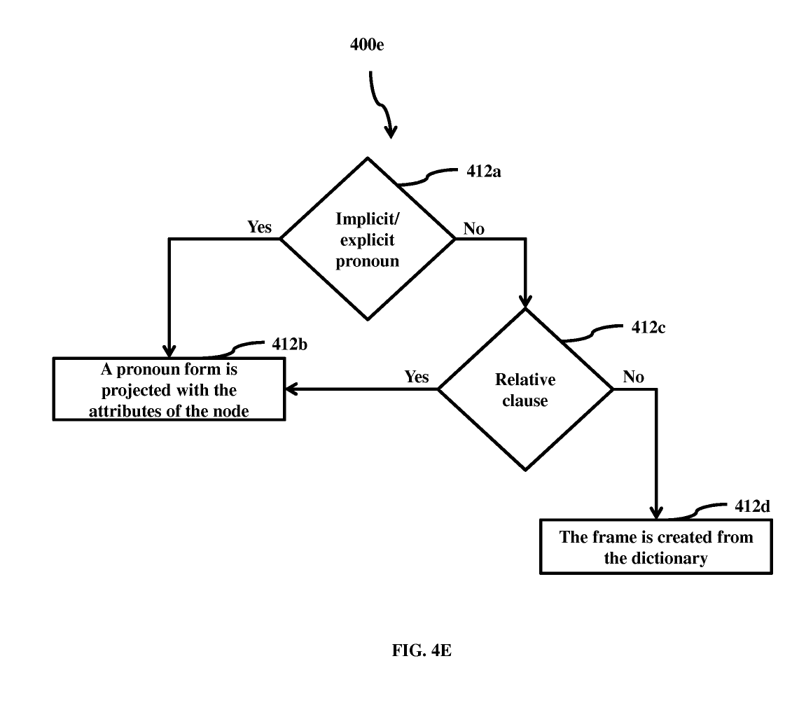

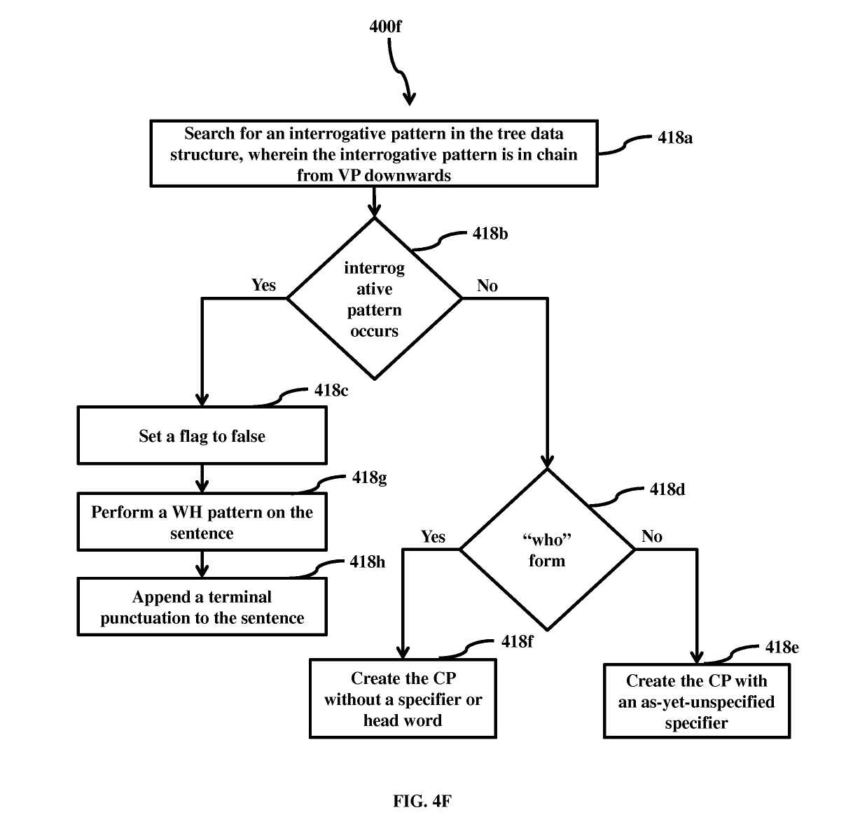

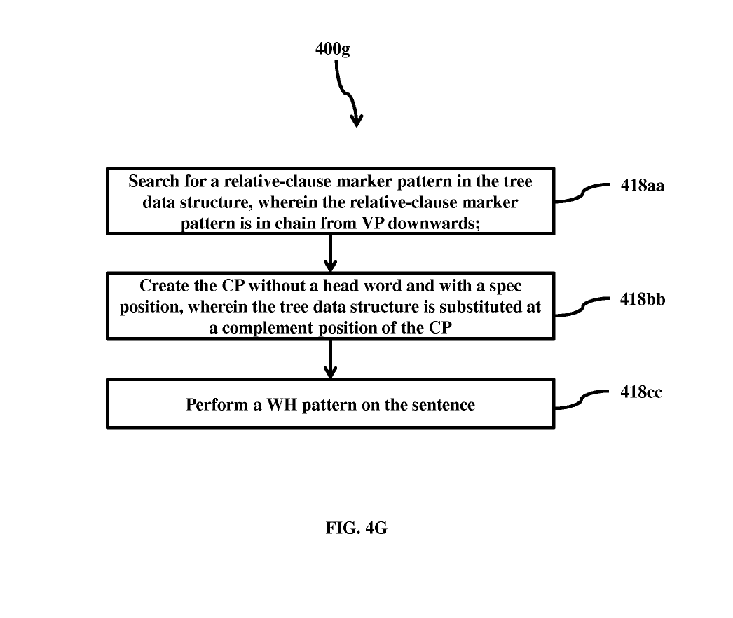

FIG. 4A is a flow chart illustrating an example method 400a for converting an interlingua into any set of natural languages, according to embodiments as disclosed herein. In an embodiment, at step 402, the method 400a includes representing a semantic sentence in the form of a graph. The graph is represented by enumerating its edges. A sub-graph is represented by assigning a sub-graph id, known as a sub-graph id or scope id, to the sub-graph. This is shown by the following example of the sentence “I saw the boy when you came.”, which is written by enumerating edges.

Agt(See.@past,I)

Obj(See.@past, Boy)

Tim(See.@past,:01)

Agt:01(Come.@past, You)

If the same word is used more than once in a sentence, the word can be disambiguated by assigning it a number. For example, in the sentence ‘a dog saw another dog’, the first dog may be represented as dog:1 and the second as dog:2.

At step 404, the method 400a includes creating the graph. The graph data structure contains graph nodes, which can either contain a word with annotation and a list of edges, or contain a special identifier marking them as a sub-graph, which can have an associated graph called the “Compound Graph”. The graph or sub-graph has one particular ‘entry node’ which (conceptually) represents the ‘head’ of the sentence. In the example previously specified, both of these kinds of nodes are described. Reviewing that example:

Agt(See.@past,I)

Obj(See.@past, Boy)

Tim(See.@past,:01)

Agt:01(Come.@past, You)

The words ‘I’, ‘see’ and ‘boy’ are nodes, and they have annotations (@past in the case of see). The words ‘you’ and ‘come’ are also nodes, but they are contained within a sub-graph called: 01, which is referred to here as a ‘sub-graph’ or a ‘scope’.

FIG. 4B is a flowchart illustrating a method 400b for creating the graph data structure out of the textual representation, according to embodiment, described herein. The method 400b includes:

At step 404a, enumerating all sub-graphs;

At step 404b, creating an empty graph for each the sub-graph;

At step 404c, converting each node of an edge into a unique node when either endpoints are pronoun, wherein each edge comprises at least two nodes. For each edge, there are two nodes. At least, the following rules are applied with each of the nodes:
a. If either endpoint (node) is a pronoun, it is converted into a unique node (unless it is explicitly disambiguated). For example, if the sentence is “I have my book”, the words “I” and “my” are both represented as 00.@1 but are separated as 00:1.@1 and 00:2.@1. (This is because there is no need to create relative pronouns for pronouns.)
b. At step 404d, creating a map (dictionary data structure) mapping node IDs to nodes.
   i. Split the node and its attributes.
   ii. For a sub-graph, set its Compound Graph to the appropriate sub-graph.
c. At step 404e, setting the entry node as such for that sub-graph, when the entry point of the graph is explicitly specified in the list of attributes of the node.
d. At step 404f, adding the edge as a relation to the two nodes (that is, add it as an in-node to the source and an out-node to the destination)

At step 404g, finding an entry for each sub-graph that doesn't have one explicitly specified. Note that the graph should be connected for it to represent a well-formed sentence.

At step 406, the method 400a includes applying rules to the graph data structure. In a preferred embodiment, attributes are explicitly specified in the graph data structure. However, in some embodiments, attributes are to be derived based on the graph data structure. For instance, the infinitive form of a word is derived from a certain kind of graph relationship. If there is an object/content/purpose/reason relationship between two verbs, it is usually an indication of an infinitive, unless the second verb also has an agent relationship with something else. For example:

Eat is the object of want in the sentence “I want to eat.”

Go is the content of tell in the sentence “I told him to go.”

Eat is the purpose of come in the sentence “I came here to eat.”

Teach is the reason of punish in the sentence “I punished him to teach him a lesson.” However, in the following examples:

Go does not get the infinitive form in the sentence “I told him that I went.” because it has an agent.

Reason of punish is steal in the sentence “I punished him because he stole.” but it has an agent.

Also, depending on the kind of source verb, there are at least three ways in which infinitive may be expressed in English—either with the word “to”, or with the gerund form of the destination verb, or without a marker. For example, the words “start”, “want”, etc. take the form “to”. For example, I started to sing. I want to eat. But the words “start” and “stop” take the gerund form. For example, I started singing. I stopped singing. (“I stopped to sing” is wrong [if sing is the object of stop].) And words like “let” don't use either form. I let him go, not “I let him to go” or “I let him going”.

At step 408, the method 400a includes resolving implicit pronouns and relative clauses. The graph created above should be a tree of graph nodes, with the following properties:

a) The entry node has no in-nodes;

b) No other node has more than one in-node; and

c) No cycle should be formed by any edge.

Breaking any of these properties may cause a non-tree to be formed, from which infer certain language properties, as described below.

FIG. 4C is a flowchart illustrating a method 400c for converting the graph data structure to a tree data structure, according to embodiment described herein. The method 400c includes:

At step 408a, traversing the graph data structure node-by-node, wherein the graph data structure is traversed from an entry node and proceeding outwards along edges. In an embodiment, the graph is traversed node-by-node, starting from the entry node and proceeding outwards along edges.

At step 408b, selecting the edge to break the graph data structure into the tree data structure. If a sub-graph is encountered, that sub-graph is converted into a tree as a preliminary step. In each node, at least the following are checked:
a. If it is the entry node, it should have no incoming edge. Otherwise, the first edge is selected for breaking.
b. If it is not the entry node, it should have at most one incoming edge. Otherwise, the second in edge is selected for breaking. Unless one of the conditions is satisfied:
   i. The second in-edge comes from the entry node, in which case the first in-edge is selected for breaking. (Otherwise, the entry node gets duplicated.) as illustrated in FIG. 4H.
   ii. The second edge is an agent in-edge. In this case, the first in-edge is selected for breaking. (Otherwise, the pronoun gets applied to the wrong word—especially reflective pronouns.) as illustrated in FIG. 4I.
c. In an embodiment, if a node is encountered for the second time, it indicates a cycle. In this case, the first in edge of the node is selected for breaking.

At step 408c, breaking the edge having a start node, an end node, and a relation. If an edge (with a start node, end node and relation) is found in this process to break.

FIG. 4D is a flowchart illustrating a method 400d for breaking the edge having a start node, an end node, and a relation, according to embodiment described herein. The method 400d includes:

At step 408ca, removing the relation from the original graph.

At step 408cb, duplicating the end node of the edge.

At step 408cc, making the duplicate node a pronoun. Since the “entry” attribute cannot be duplicated, the attribute is removed from the duplicate, if found.

At step 408cd, connecting the duplicate node to the start node, wherein the edge is broken into the start node and the duplicate, and the end-node along with rest of the graph data structure. Now the edge is broken into two: one with the start node and the duplicate, but in which the duplicate has only one in-node which is the start-node; and another with the end-node and the rest of the graph, in which the offending in-node has been removed.

At step 408ce, determining whether the resulting graph data structure is one of connected and broken into two fragments by the edge-breaking. At step 408cf, inferring a pronoun in response to determining that the resulting graph data structure is connected. The new node is marked as a pronoun.

At step 408cg, inferring a relative clause in response to determining that the resulting graph data structure is a fragment involves taking one of the two duplicate nodes, and creating a sub-graph out of all the nodes connected to it. The choice of which duplicate node to pick, is based on which fragment has the entry node. Further, a relationship between the remaining node and the new sub-graph is added. The relationship is called “ra” which stands for “right adjunct”, a form of adjective relationship. Further, the new node is marked as an “RC (00.@whr)”, which means it is a “wh”-word-signifying relative clause.

In an embodiment, if any edge has been broken, the method 400d is rerun.

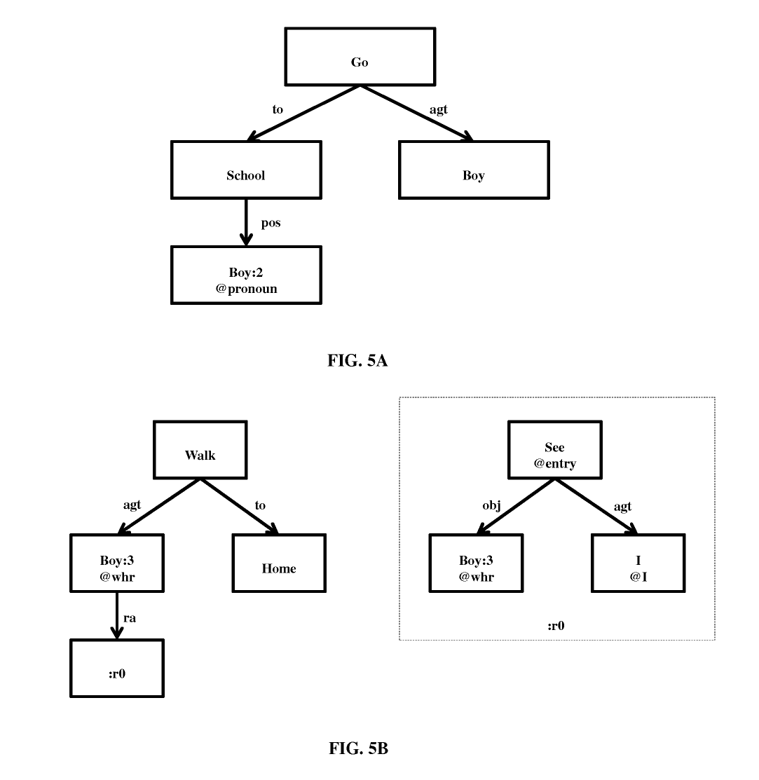

FIG. 5A shows an example of a sentence where a pronoun is inferred, according to embodiments at disclosed herein. Let's consider a sentence as “The boy goes to his school”. A graph representing the sentence where the pronoun is inferred is shown in the FIG. 5A.

FIG. 5B shows an example of a sentence where a relative clause is introduced, according to embodiments at disclosed herein. Let's consider a sentence as “The boy whom I see is walking home”. A graph representing the sentence with introduction of the relative clause is shown in the FIG. 5B.

At step 410, the method 400a includes adding Lexical annotation and attributes from dictionary. For each graph node, the dictionary entry for that graph node is associated with it. The dictionary contains a number of properties of a word sense. It contains its root form, morphological properties, part of speech, and framing structure (transitive, intransitive, etc.).

In this process, explicit pronouns alone are handled differently: a special dictionary entry, called “PRO”, is attached to it. Implicit pronouns are still given the dictionary entry of the word they represent.

In this process, a few new attributes may get added onto the node, derived from the dictionary. For example, the attributes @proper, @female and @male may come into the node from the dictionary. These are called “extended attributes” or “xattrs”.

It is to be noted that a dictionary entry is not for a word, but for a word sense. For a word like ‘trunk’, for example, there are multiple meanings, and each has a separate dictionary entry. There may also be subtle shades of meaning for which separate dictionary entries are present. For example, “I want to talk” and “I want him to talk” have almost the same meaning, but would be represented as different word senses. A general rule of thumb (not always followed) is that if two meanings can be represented with the same picture, they would have the same dictionary entry; otherwise, they would be represented with different ones.

A frame is an elementary xtree which is projected from a word. The frame specifies the spec and complement arguments which are taken by the tree. Frames are usually very simple for nouns and adjectives, and show substantial variation only in the case of verbs. In one embodiment of the proposed system, the following table lists some examples of framing rules:

| | | CONSTRAINTS |
|---|---|---|
| FRAME | X-BAR STRUCTURE | AND ATTRS |
| Noun | No spec, no complement | |
| Proper noun | No spec, no complement | PROPER attribute is |
| | | set |
| Adjective | No spec, no complement | |
| Transitive verb | DP Spec, any | |
| | complement | |
| Ditransitive verb di- | Shell - two VPs chained, | Both specs should |
| animate (e.g. give the | both with DP spec. Lower | have attribute ANM |
| boy a book) | verb has any complement. | |
| | (Has 2 specs and 1 | |
| | complement positions) | |

At step 412, the method 400a includes creating elementary trees of the words. In this step, each node gets an x-tree associated with it. The creation of the x tree depends on the kind of node it is.

FIG. 4E is a flowchart illustrating a method 400e for creating the xtree depends on the kind of node it is, according to embodiment described herein. The method 400e includes the following steps:

At step 412a, determining whether the node represents an implicit/explicit pronoun;

At step 412b, if it is determined that as the implicit/explicit pronoun, caused by inference, a pronoun form is projected with the attributes of the node. (If inference cannot be done, a wildcard form with the name ‘X’ is projected.)

At step 412c, determining that the node represents a relative clause in response to determining that it is not an implicit/explicit pronoun.

At step 412d, if it is determined that it is not a pronoun and not a relative clause, the framing rule is created from the dictionary. A framing rule contains a “template” to create a tree. A tree is projected/created based on this template. For example, a template could be related to intransitive verbs or transitive verbs.

Further at step 412d, if it is determined that the node represents either an explicit pronoun or a relative clause, a pronoun form is projected with the attributes of the node.

The projection of pronoun form may include:

1. Inferring the type of the pronoun from its attributes.

2. Creating a basic tree with the part of speech inferred above.

3. Applying the default 3rd-person, if a person is not specified.

4. Inferring “animate” from the existence of the pronouns male, female, lst/2nd person, and question pronoun.

5. Setting all the attributes of the node to the tree, setting the tree animate attribute if inferred, and setting the tree pronoun attribute.

6. Setting default noun-phrase attributes, like 3rd person, singular, neuter.

7. From the x-tree's attributes, propagating NP properties alone to the x-tree's word.

8. Setting the dictionary entry to none.

Projection of other elementary trees from a Framing Rule includes:

1. Transferring attributes of the node to the tree as properties.

2. Copying “Extended attributes” from the dictionary to the tree as properties.

3. Based on the kind of word (part of speech), projecting a higher-level “inflection tree” on top of the basic tree.

Now, the details of projection of “inflection tree” for various parts of speech follow.

Projection of the “Inflection Tree” for Verbs Includes:

1. Default properties are filled into the tree using attribute rules. For example, if no tense is specified, it is considered to be in the present tense. If no aspect/modality is specified (out of ‘had’, ‘-ing’, ‘will’, ‘can’, ‘may’, ‘should’), it is considered to be a ‘do’-creating aspect.

2. The attributes are taken in sequence, starting from the one that associates most closely with the verb to the one that is most distant, and for each one, three things are done:
a. A new Inflection Phrase (IP) tree is created with a relevant headword;
b. The existing Inflection Phrase (IP) or Verb Phrase (VP) tree is substituted as the complement of the new tree; and
c. A relevant morphological property is set for the headword of the existing IP or VP tree.

3. In one embodiment, some examples of rules to project trees from headwords, and set properties for the existing tree, are shown below:

| | Headword of new | Property added to |
|---|---|---|
| Attribute | tree | old tree |
| continuous | be | _gerund |
| Anterior (perfect) | have | _participle |
| infinitive | to | None |
| simple | do | None |
| ability | can | None |
| future | will | None |

Then the past and present tenses add a morphological attribute to the last-created tree, _past and _present respectively. So, for example, the form “could have been going” works by:

1. Starting with “go”

2. Adding “be” and changing “go” to gerund (going)

3. Adding “have” and changing “be” to participle (been)

4. Adding “can” (no change to “have”)

5. Changing “can” to past (could).

Note that the changes of morphological form do not actually happen at this stage; they are marked on the word, and take effect during morphological transformation, later.

If the node is negated, the morphological attribute “not” is added to the highest headword of the tree. If the node has an interrogative attribute, the property is set in the tree.

Projection of “Inflection Tree” for Nouns Includes:

1. Set default noun-phrase attributes, which in one embodiment for the English language are 3rd person, singular, neuter.

2. A generic Determiner Phrase (DP) tree is created (with the dummy headword ‘-det’), and the noun phrase (NP) tree is substituted in its complement position.

3. DP attributes from the NP tree are propagated upwards to the DP's headword. This is necessary for appropriate inflection of the article/determiner.

4. NP attributes from the NP tree are propagated downwards to the NP's headword.

5. If any of the node's attributes happen to be prepositional phrase (PP) attributes (like @in, @on), a PP is inferred.

Projection of “Inflection Tree” for Adjectives and Adverbs Includes:

1. For an adjective or adverb, the highest projection is a Magnification Phrase (MagP). Degree information (like more, most or neutral) is in the inflection of the adjective/adverb. The Adjective Phrase or Adverb Phrase (respectively JP or AP) is substituted in the complement position of the MagP.

2. Adjectival properties like “@more” and “@most” are propagated downwards to the headword of the JP/AP. This is in order to inflect the word (for example, to inflect big to bigger or biggest).

In an embodiment, an x-tree structure is defined as a building block of the syntactic structure of the system. The x-tree comprises of nodes, and each node has at least:
1. A label (the word it represents or the position in the tree)
2. Pointers to define the tree structure (left, right, parent)
3. A link to the tree to which the node belongs
4. Morphological properties of the word
5. If it is a position label (not a word), constraints on the kinds of trees that may be substituted in that position. (For example, some verbs project a tree whose spec position can only be an animate word.)

This x-tree structure has at least the following elements:
1. A structure which consists of a maximal projection (MP) node, one or more intermediate projection (IP) nodes, and a head (H) node.
2. Pointers to parent, specifier (spec) and complement (comp) xtrees (these pointers are pointers to nodes whose tree links are the actual trees substituted in these positions). The parent pointer is used for detaching a sub-tree from a main tree.
3. Pointer to adjunct x-trees (these pointers are pointers to nodes whose tree links are the actual trees substituted in these positions)
4. A “head” word. This usually contains a word sense. (The word is contained in the label of a node.)
5. Properties for the tree.

In an embodiment, a tree can have a ‘trace’ to another part of it. This may be represented by having the maximal projection (MP) node contain a trace id and have a trace pointer to another tree. The following operations can be defined on a tree:

1. Initializing with a pattern

2. Substitution of a tree

3. Adjunction of a tree

4. Detachment and movement of a sub-tree from one location to another

5. Leaf traversal and application of a function with accumulation of the result

Searching/Pattern-Matching within a Tree

In an embodiment, a template-matching engine allows for searching and pattern-matching within a tree. Templates allows structural (i.e. type), content (i.e. value), as well as property constraints to be specified as search parameters. For example, the pattern a pattern x(Complement z) matches x to a sub-tree and z to its complement. Constraints on x and z can be specified, for example [x is an IP, z is a VP]. In this case, the template will only match x to a sub-tree of type IP which has a complement VP. It is also possible to match along a complement chain (chain formed by a tree, its complement, and all complements of complements) by specifying a wild-card Complement*, so that x(Complement* z) with the same constraints [x is an IP, z is a VP] finds an IP which has a VP somewhere in its complement chain, returns the IP as x, and returns the VP as z.

### Graph-to-Tree Rule Matching

A graph-to-tree rule (also called a semantic rule) consists of the following:
1. Edge pattern (a pattern describing an edge of the graph data structure);
2. 2 node tree patterns (patterns describing the xtrees corresponding to each graph node of the graph edge);
3. An output pattern, which describes the way in which the two node trees are manipulated in the event of a match; and
4. The output variable

The first two rule components are called the Left hand side (LHS), and the third and fourth are called the Right hand side (RHS). The output pattern consists of a tree pattern, along with various variables which are inferred from the rule matching phase; and properties that are to be applied on the trees if pattern match is successful. Here is an example of a graph-to-tree rule LHS: tim(x,y)|x(C*:n);[x=IP,n=VP]|y(C*:z);[y=MP,z=AP,z.LEFT=!NULL]

In an embodiment, the components above are separated by a pipe symbol. The first component is the edge pattern, and the second and third components are node patterns. In this example, “tim(x, y)” pattern is used to identify an edge in the tree which has the “tim” relationship. When it identifies such an edge, the variables x and y are assigned to the trees corresponding to the two nodes of the edge. The tree x is matched to the pattern x(C*:n);[x=IP, n=VP], and the tree y is matched to the pattern y(C*:z);[y=MP, z=AP, z.LEFT=!NULL]. If there is a match, the variables x, n, y and z are all assigned as part of the match.

Here is an example of the corresponding graph-to-tree rule RHS: n(Al2:y)|x

The components are separated by a pipe symbol. In this example, the interpretation is that the tree y is to be adjoined to the tree n, with a left adjunction with a priority of 2. The example also states that the ‘return’ value—i.e. the output of the semantic rule application—is the variable x. In other words, the nodes x and y are to be logically coalesced into a single node which has the tree x.

At step 416, the method 400a includes applying the graph-to-tree rules configured in the rule engine 106. In an embodiment, to apply the graph-to-tree rules, the graph is traversed in a particular order of edge types and checks each edge against a list of patterns of all possible semantic rules. When a match is found, the appropriate RHS action is taken. In an embodiment, a few caveats are described below:

1. When a relative clause is adjoined, the movements should be done in the imbedding clause before the adjunction. So the ‘ra’ relationship is alone handled differently. An example of why this is needed:
“The man whose house I stayed in is my father's friend.”—Here, ‘wh movement’ transforms the fragment “I stayed in whose house” to “whose house I stayed in”. In the form that the ‘wh movement’ is currently written, this movement will not happen if the adjunction happens first (to form “the man I stayed in whose house”).
2. When sub-graphs are encountered, the semantic rule check is done between the entry nodes of the sub-graphs.
3. When a rule is successfully applied, the method automatically ‘relation-marks’ the destination tree. This relationship marker is essentially a case-marker, which helps identify when a noun is to be inflected accusative (for example when it is the destination of an “obj” relationship) or nominative (for example when it is the destination of an agt relationship). This property is set, not only in the tree, but also as a morphological property of its word.
4. When the node search rule matches more than one possible position in a tree, only ONE of the positions is taken as the true match. The position is either the highest or the lowest, as specified in the rule.

### Different Kinds of Graph-to-Tree Rules

Further considerations in graph-to-tree rule formation and application are detailed hereunder:

1. Searching for highest vs. lowest complements: In some cases, a template for a wildcard should match the lowest hit. For example, in an obj relationship for a shell frame, there may be two matches to the general pattern (which is x(C*:z);[x=IP, z=VP])—the first being the shell VP, and the second being the lower VP. It needs to be specified that the semantic rule is to be applied to the lower of the two matches. This is true in many other VP shell cases also (for example, the “ben”, “cnt”, “to”, and “frm”, relationships).
2. Adjunction order: When the output of a rule is an adjunction, the location at which the adjunction must be inserted follows a certain ‘order of adjectives’, in which the quantity (for example) associates farther from the noun than the modifier (which is why we say ‘two red cars’ instead of ‘red two cars’). This is handled by giving the “Ar” and “Al” outputs a number, which indicates the ‘priority’ of the insertion.
3. Creation of new properties: Sometimes, new properties are added due to rule application; for example, if the “qua” relation takes a number argument which is greater than one, the source of the “qua” relation should be made a plural.
4. Order of application: The semantic rules are to be applied leaf-inwards, i.e. starting at the leaves of the tree form of graph and moving towards the entry node. There is an order in which semantic rules should be applied to edges among sibling edges.
In a preferred embodiment, the more closely-associating relations may be handled first, before the more complex ones are handled. An example is the ‘and’ relation. Take the sentence “I went and he came”. Here, if the ‘and’ relation between ‘went’ and ‘came’ is handled first to create the fragment ‘went and came’, it may not be possible to then affix the ‘I’ and ‘he’ in appropriate specifier positions (as the agent rule demands) because the information of which tree's specifier takes which argument will no longer be available.
5. Need for output variable: Sometimes, a relation is applied by creating an ‘upper tree’ in which one or both of the nodes are embedded. A typical example is the ‘aoj’ relationship. Take the semantic interlingua sentence: aoj (black, sheep). In this example, the MagP corresponding to black should be affixed to the complement position, and the DP corresponding to sheep should be affixed to the spec position, of the word ‘is’, to yield the sentence “the sheep is black”. But note that when the nodes coalesce, the tree with head ‘is’ should be returned, and not either of the trees ‘black’ or ‘sheep’. This is seen in the example ‘I told him the sheep is black’, in which the node-joining process should create the fragment ‘the sheep is black’ (headed by the word ‘is’) and then apply the content relation between ‘tell’ and this entire fragment.

Example graph-to-tree rules for different relations in English

| | | |
|---|---|---|
| and, | Binary relation between | Create a CP with the head ‘and’/‘or’ |
| or | two entities of the same | and complement y. Right-adjoin far |
| | type | to x. For nouns, mark x as plural. |
| | (noun/verb/descriptor) | |
| agt | Agent relationship | Put y in the specifier of the highest |
| | between a verb and a | verbal complement of x |
| | noun | |
| obj | Object relation of a verb | Substitute y in the lowest verbal |
| | and all types | complement of x. |
| gol | Goal relation of a verb | Create a PP with head ‘to’ and |
| | and a noun (e.g. talk to | complement y. Adjoin right closely to |
| | him) | x. Mark verb as di-transitive to trigger |
| | | possible movement. |
| ben | Beneficiary relation of a | Create a PP with head ‘for’ and |
| | verb and noun (e.g. bring | complement y. Right adjoin closely to |
| | a book for him) | x. Mark verb as di-transitive. |

At step 418, the method 400a includes defining and applying movement rules, which are tree-to-tree transformation rules. When all the graph-to-tree relations have been processed in the graph, there remains only one, highest-level tree into which all the other have collapsed. This is the “D-structure” of the overall sentence. The next step is to convert this into the “S-structure” of the sentence through the application of movement rules.

### Movement Rules

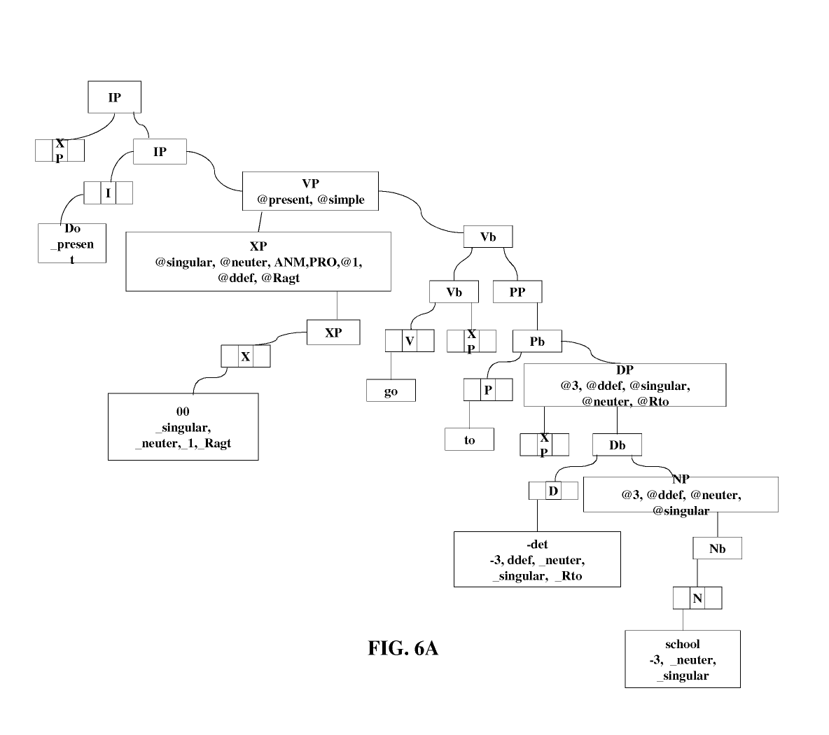

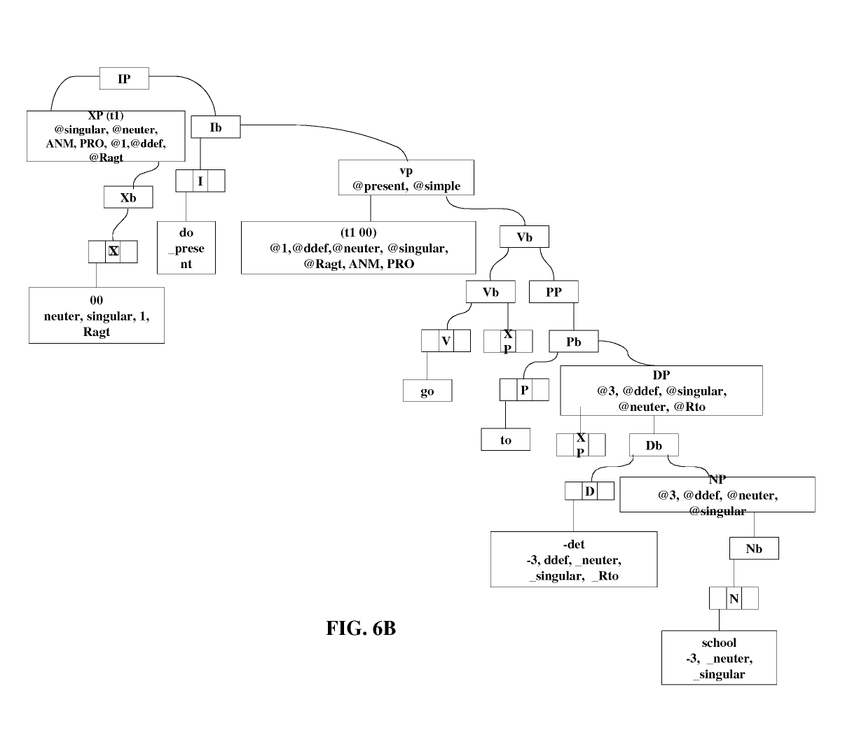

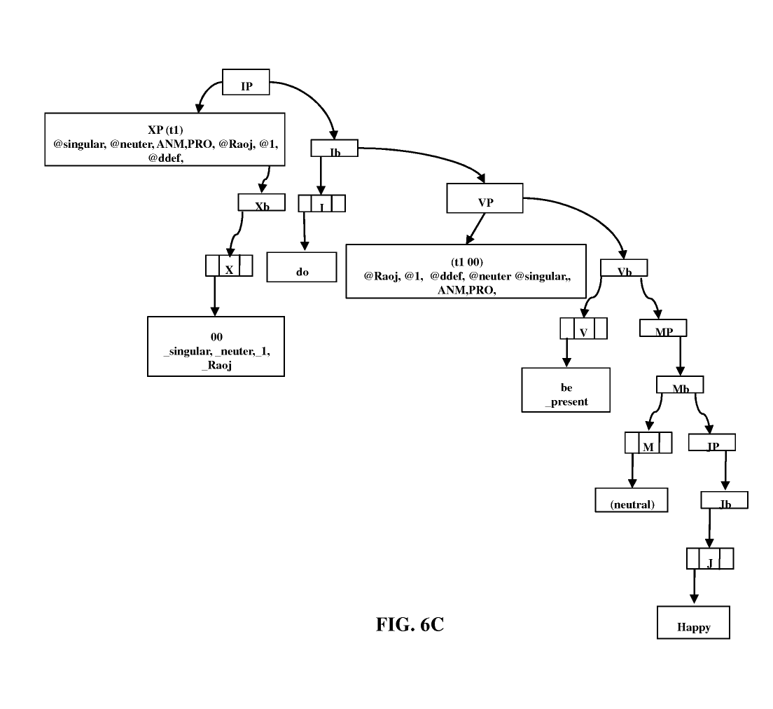

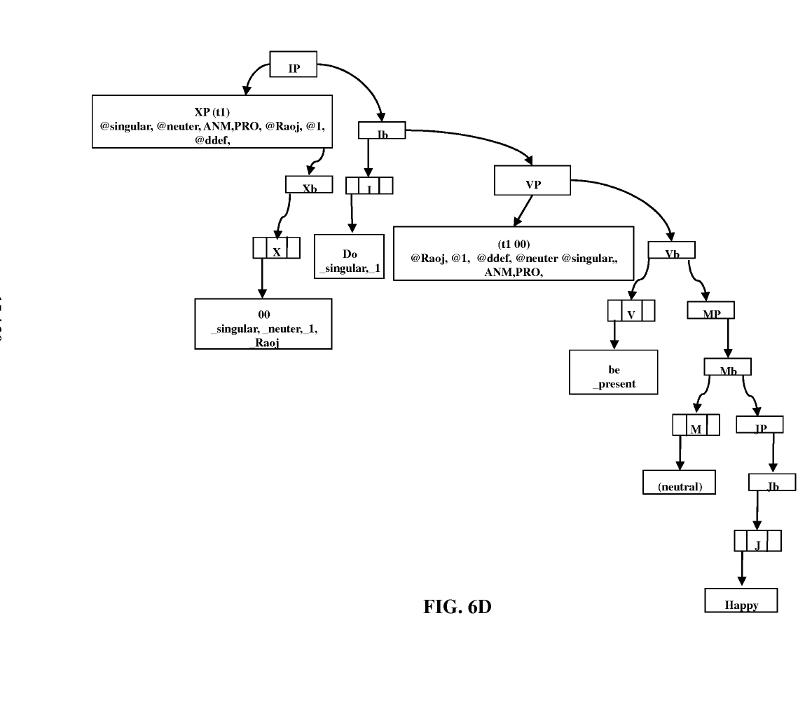

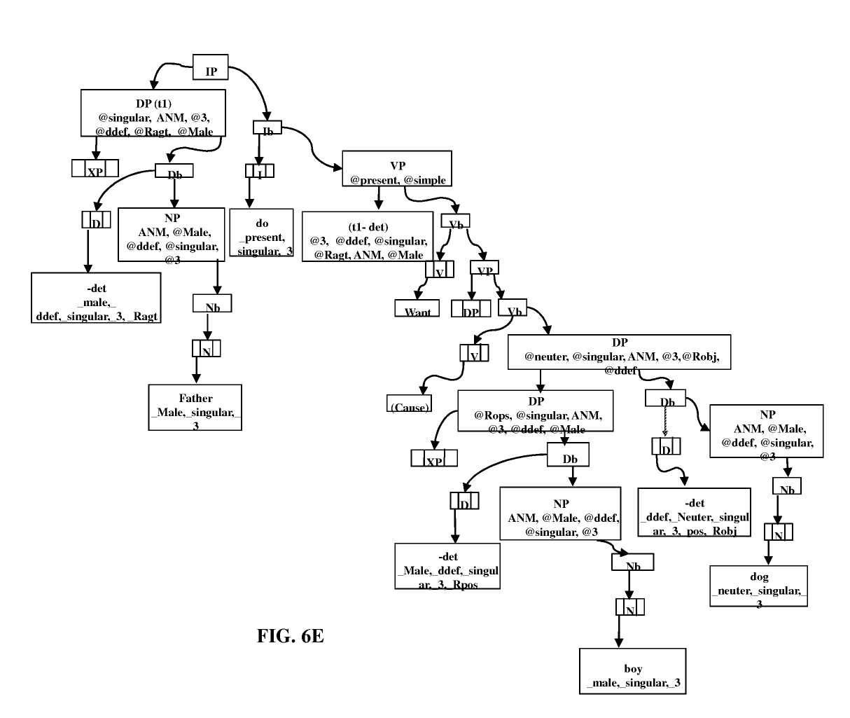

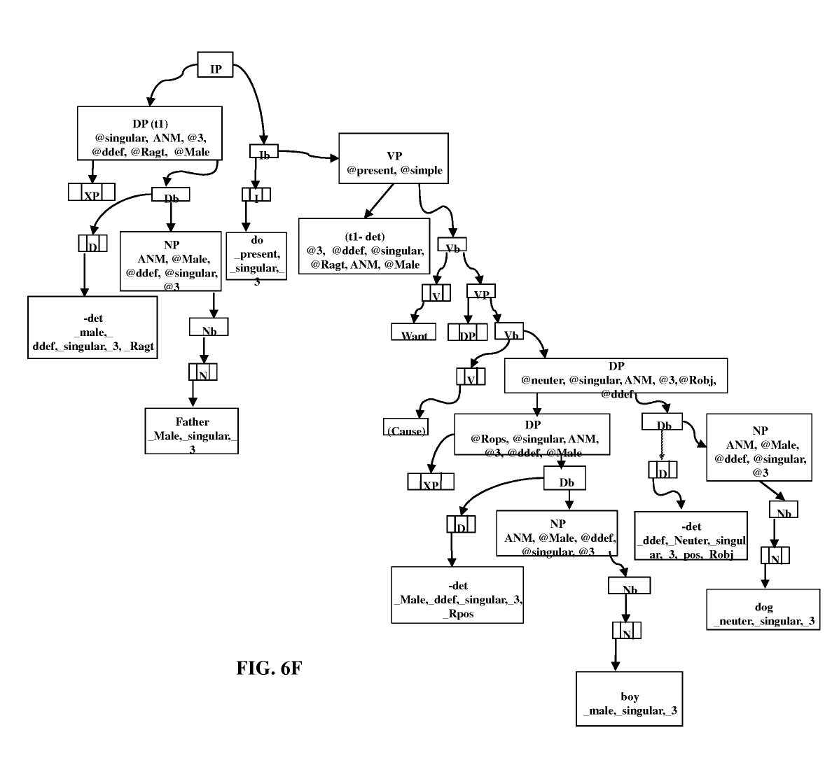

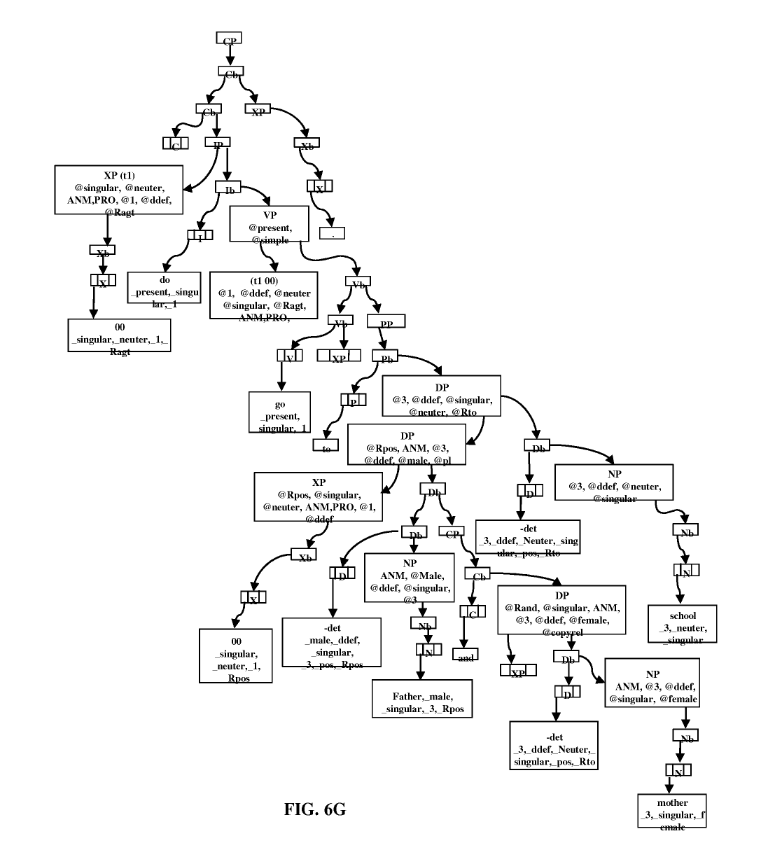

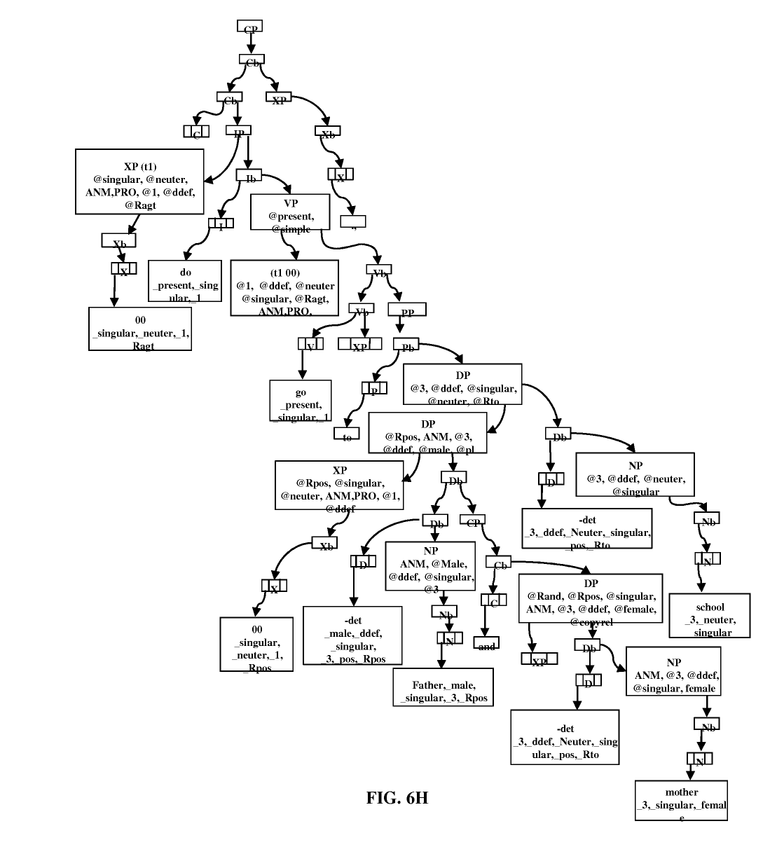

FIGS. 6A to 6H shows examples of various movements, according to embodiments disclosed herein. Movement involves detaching a sub-tree from one location and attaching it to another. A movement rule contains three components: a pattern template and constraint set that identifies the sub-tree to detach, a pattern template and constraint set that identifies a location at which the sub-tree is attached, and an operation that specifies any further steps (such as copying or creating attributes) that accompany the movement. In an embodiment, one movement rule governs the movement of specifier of a verb from VP to IP, and up the IP chain (IP to IP). This move is needed to move the subject to the front of the sentence or clause. An example of VP to IP movement for a sentence: “I go to School” is shown in the FIGS. 6A and 6B, where FIG. 6A shows the tree before movements, and FIG. 6B shows the tree after movements.

In an embodiment, copying the properties of the spec of a verb to its head (for inflection) is described. For example, the sentence “I am fine” vs. “you are fine”—the attribute @2 should descend from the subject to the noun. This is done by this movement. Note that in English, only the person (1^{st}/2^{nd}/3^{rd}) and number (sing/plural) are relevant for verb inflection. An example of the agreement movement for a sentence: “I am happy” is shown in the FIGS. 6C and 6D, where FIG. 6C shows the tree before movements, and FIG. 6D shows the tree after movements.

In an embodiment, setting the _pos morphological property to nouns whose DPs was in a pos relationship. This is how, for example, the word “man” in “man's brother” gets the possessive—the DP of ‘man’ gets annotated with @Rpos when it is relation-marked during semantic rule application. Then this @Rpos has to descend to ‘man’ so that it becomes man's. An example of the POS movement for a sentence: “The father wants the boy's dog” is shown in the FIGS. 6E and 6F, where FIG. 6E shows the tree before movements, and FIG. 6F shows the tree after movements.

At this step, the CP is created, as described in the section “CP creation”.

In an embodiment, copying relations for a conjunction is described. This is needed, because in the case of a sentence like “my brother's and my house”, the morphology of possession should apply to both ends of the ‘and’ relationship. But in the semantic graph, it applies only to one. This movement transfers the morphological relationship attribute from one of the conjunction arguments to both of them. An example of the copy relation movement for conjunctions for a sentence: “I go to my father's and mother's school” is shown in the FIGS. 6G and 6H, where FIG. 6G shows the tree before movements, and FIG. 6H shows the tree after movements.

### CP Creation

In the proposed system and method, the CP structure is created in the movement phase. The CP creation process takes the top most IP, and substitutes it in the complement position of a CP.

FIG. 4F is a flowchart illustrating a method 400f for creating a CP for a full sentence, according to embodiment described herein. In an embodiment, the method 400f includes:

At step 418a, searching for an interrogative pattern in the tree data structure, wherein the interrogative pattern is in chain from VP downwards. In an embodiment, search for an interrogative pattern somewhere in the tree (starting from the VP). The interrogative pattern is simply the pattern “Q (00.@wh)” somewhere in the chain from the VP downwards.

At step 418b, determining whether the interrogative pattern occurs. At step 418c, setting a flag to false in response to determining that the interrogative pattern occurs.

If the interrogative pattern occurs on a node that is marked with the attribute “@Ragt”, i.e. it is case-marked as an agent (asking the question “who”), a flag called “ISNTWHO” is set to FALSE. This is because in English the question “who” alone does not have a movement/do-substitution. E.g., the D structure sentence “I gave the book to whom” gets transformed to “whom did I give the book to”, where the word “whom” moved to the CP's head and the word “did” is retained. However, the sentence “Who gave the book to him” does not feature the word “did”. Thus, “who” has to be handled separately. For example, the D structure sentence “I gave the book to whom” gets transformed to “whom did I give the book to”, where the word “whom” moved to the CP's head and the word “did” is retained. However, the sentence “Who gave the book to him” does not feature the word “did”. Thus, the word “who” has to be handled separately.

At step 418d, determining whether the sentence is in “who” form. At step 418e, if the “Q (00.@wh)” pattern does occur in the sentence, and it is not a “who” form, then the sentence is an interrogative sentence. It is marked with the attribute @interrogative. The CP is created with an as-yet-unspecified specifier. The head of the top IP is detached and is inserted as the CP's head. (This is usually the word “do”.) The top IP is attached to the complement position of the CP.

At step 418e, if the pattern does not occur, or if it is the “who” form, then the CP is created without a specifier or head word, and the top IP is substituted in the complement position of the CP. Note that polar questions do not feature the “Q (00.@wh)” pattern. Instead, the head IP is marked with the attribute @interrogative directly in the input.

At step 418g, WH movement is done on the sentence, as described below. At step 418h, appending a terminal punctuation to the sentence. This is done if the search for “Q (00.@wh)” resulted in any positive matches (regardless of whether it is a “who” or not), OR if the sentence is marked with a @interrogative. The latter can happen without the former in the case of polar (Y/N) questions. If either of these conditions holds, the terminal punctuation is a question-mark (“?”). Otherwise, it is a period (“.”). The punctuation is added to the tree by creating a basic X-bar tree and right-adjoined to the CP.

FIG. 4G is a flowchart illustrating a method 400g for creating a CP for a relative clause, according to embodiment described herein. The method 400g includes the following steps:

At step 418aa, searching for a relative-clause marker pattern in the tree data structure, wherein the relative-clause marker pattern is in chain from VP downwards. In an embodiment, search for a relative-clause marker pattern somewhere in the tree (starting from the VP). The relative-clause pattern is simply the pattern “RC (00.@whr)” somewhere in the chain from the VP downwards. Note that this is different from the question pattern “Q (00.@wh)” and is introduced into the tree during the graph-to-tree conversion.

At step 418bb, if the relative-clause marker is found, a CP is created without a head word and with a spec position, and the tree is substituted in the complement position of the CP.

At step 418bb, performing a WH pattern on the sentence. This is called “Relative WH movement” and is described below under the “movement rules” section of the description.

At the end of movement application, the final tree always has the following form:
1. The top-most tree is a “CP”, which defines the sentence structure. The CP may also include punctuations,
2. In some instances, the CP may be followed by more CPs.
3. Beneath the CP is a sequence of “IPs” which ends in a VP. This VP is the main verb of the sentence.
4. The rest of the sentence is in various specifier and complement positions of the CP/IP/VP tree.

### Morphology Rule Application

At step 420, the method 400a includes defining and applying morphology rules.

At this stage, the leaves are not yet ‘words’—they are word-nodes with various attributes. The transformation of these word-nodes to words is a morphological operation (where the attributes cause the words to take on various tense, aspect and agreement related forms) and is the step required for converting the tree form of a sentence into a linear form. The linear form may require further transformations to result in a sentence.

In one embodiment, morphological transformation includes the following rules:

1. Some words are unvoiced, represented by putting them in brackets. These words have an empty morphological transformation.
2. Prepositions are not inflected; the word is directly returned.
3. Pronouns are inflected as follows:
a. Question words, indicated by _wh, are transformed based on the relation-marker into questions like who, whom, what, or the like.
b. Personal pronouns are transformed based on person, number, gender and semantic role.
   4. Determiners are inflected as follows:
a. For modifier and possessive semantic roles, no determiner is voiced.
b. The other determiners are inflected from the attributes defined on them. This includes the determiners these, this, that, those, the, and a.
c. In other cases, determiner morphologies are suppressed. One is for indefinite plurals, which in English do not appear to have a voiced determiner.
   5. Nouns are inflected in English for plural and possession.
   6. Verbs (and IPs and CPs) are inflected based on negation, word form, person and number.
   7. Adjectives are inflected based on comparative or superlative forms.
   8. All other words—including adverbs—do not have inflections and the lemma is directly returned.

### Sequence Transformation Rules

At step 422, the method 400a includes handling sentence operations using sequence transformation rules. In an embodiment, some sentence operations appear to operate on the final list of words, and these sentence operations are handled by the sequence transformation rules. These rules operate on the list of words. Two examples of sequence transformation rules in English are given below:
1. The definite determiner is suppressed before question words. Thus, ‘the which’ or ‘the how’ or ‘the how many’ are transformed to suppress the leading ‘the’.
2. Dangling preposition transformation. This transforms, for example, constructions like ‘To whom did you give the book?’ to ‘Whom did you give the book to?’ This handles an artifact of combining ditransitive movement and wh-movement.

At step 424, the method 400a includes convert the sequence of words into a sentence. In an embodiment, this involves a few steps additional to just listing the words separated by spaces, and those steps are:
1. Capitalizing the first word of a sentence (including the first word within quoted speech)
2. Conversion of ‘a’ to ‘an’ when followed by a word beginning with a vowel
3. Adding quote marks around quoted speech, and inserting a comma before the quote starts

The final output, then, is a sentence which is a faithful reproduction of the semantic input.

The various actions, acts, blocks, steps, and the like in method 400a may be performed in the order presented, in a different order or simultaneously. Further, in some embodiments, some actions, acts, blocks, steps, and the like may be omitted, added, modified, skipped, and the like without departing from the scope of the invention.

Although the example embodiments use a specific example of an interlingua that the conversion system is able to convert to English, it is to be understood that other embodiments are not limited thereto. Specific reference has been made to U.S. Pat. No. 8,712,780 to Ajit Narayanan. (Dec. 8, 2010) entitled “Systems and methods for picture based communication”, for a brief discussion on picture based interlingua. While some of the example embodiments described herein use a picture based interlingua to convert to the natural language English, the conversion system disclosed is capable of converting a large class of generic, semantically-oriented interlingua into any natural language. Further, it will be evident that the proposed system can more broadly be applied to convert any small or large class of interlingua into a set of natural languages.

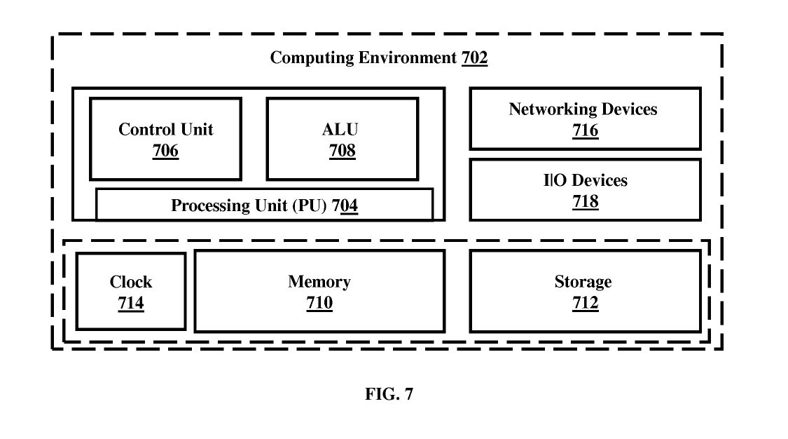

FIG. 7 depicts a computing environment implementing the method and system as described herein, in accordance to embodiments disclosed herein. As depicted, the computing environment 702 comprises at least one processing unit 704 that is equipped with a control unit 706 and an Arithmetic Logic Unit (ALU) 708, a memory 710, a storage unit 712, a clock chip 714, plurality of networking devices 716, and a plurality Input output (I/O) devices 718. The processing unit 704 is responsible for processing the instructions of the technique. The processing unit 704 receives commands from the control unit 706 in order to perform its processing. Further, any logical and arithmetic operations involved in the execution of the instructions are computed with the help of the ALU 708.

The overall computing environment 702 can be composed of multiple homogeneous and/or heterogeneous cores, multiple CPUs of different kinds, special media and other accelerators. The processing unit 704 is responsible for processing the instructions of the technique. The processing unit 704 receives commands from the control unit 706 in order to perform its processing. Further, any logical and arithmetic operations involved in the execution of the instructions are computed with the help of the ALU 708. Further, the plurality of process units may be located on a single chip or over multiple chips.

The technique comprising of instructions and codes required for the implementation are stored in either the memory unit 710 or the storage 712 or both. At the time of execution, the instructions may be fetched from the corresponding memory or storage 712, and executed by the processing unit 704. The processing unit 704 synchronizes the operations and executes the instructions based on the timing signals generated by the clock chip 714.

The embodiments disclosed herein can be implemented through at least one software program running on at least one hardware device and performing network management functions to control the network elements. The network elements according to various embodiments include blocks which can be at least one of a hardware device, or a combination of hardware device(s) and software module(s).

It is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein The method embodiments described herein could be implemented in pure hardware, or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A computerized method for language generation from a semantic interlingua for natural language communication, the method comprising:
generating, by a control module, a graph data structure of a semantic interlingua using at least one graph rule applied by a rule engine;
generating, by said control module, a tree data structure based on an analysis of said graph data structure, wherein said graph data structure is analyzed based on at least one tree rule applied by the rule engine;
transforming, by a sequence converter, said tree data structure into a sentence of target language, wherein said tree data structure is transformed based on at least one sequence transformation rule applied by the rule engine; and
communicating said sentence using an user interface module in one of audio, visual, or audio-visual format.

2. The method of claim 1, wherein said graph data structure comprises a plurality of graph nodes indicating at least one of a word-sense with annotations, a set of attributes, a special identifier indicating a sub-graph, and a list of edges.

3. The method of claim 2, wherein each said graph node is associated with a dictionary, wherein said dictionary comprises at least one of root form of said word sense, morphological properties, parts of speech, semantic attributes, and framing structure.

4. The method of claim 2, wherein said plurality of nodes comprises an entry node representing an entry-point for parsing said sentence.

5. The method of claim 1, wherein generating, by said control module, said graph data structure of said semantic interlingua using said at least one graph rule from the rule engine comprises:
enumerating all sub-graphs;
creating an empty graph for each said sub-graph;
converting each node of an edge into a unique node when either endpoints are pronoun, wherein each said edge comprises at least two nodes;
creating a map for mapping node identifiers to each said node;
setting an entry point for each subgraph; and
adding said edge as a relation to said at least two nodes.

6. The method of claim 2, wherein at least one of said word sense, annotations, set of attributes, special identifier indicating sub-graph, and list of edges associated with each said graph node in said graph data structure defines a transformation of said graph node, wherein said graph node or graph structure is modified based on at least one graph rule.

7. The method of claim 6, wherein said graph rule comprises of a pattern that specifies that an attribute is one of, exactly one of, or a maximum of one of a given list of attributes.

8. The method of claim 6, wherein said graph rule comprises graph pattern, constraints on said pattern, and output operation.

9. The method of claim 1, wherein modifying, by said control module, said graph data structure based on said analysis of said graph data structure comprises:
traversing said graph data structure node-by-node, wherein said graph data structure is traversed from an entry node and proceeding outwards along edges;
selecting edges in said graph data structure from among those which
create a cycle in the graph, or which cause an entry node to have at least one input edge,
cause a node that is not an entry node to have two or more input edges, and
cause a node to have more than one input edges of give type;
from said selected edges, breaking edges having a start node, an end node, and a relation.

10. The method of claim 9, wherein breaking edges comprises:
removing said relation from said graph data structure;
duplicating said end node of said edge;
marking said duplicate node with a pronoun attribute;
connecting said duplicate node to said start node, wherein said edge is broken into said start node and said duplicate, and said end-node along with rest of said graph data structure; and
determining whether resulting graph data structure is one of connected and broken into two fragments by the edge-breaking.

11. The method of claim 10, wherein said method further comprises inferring a pronoun when said resulting graph is determined as connected.

12. The method of claim 10, wherein said method further comprises inferring a relative clause when said resulting graph is determined as fragment.

13. The method of claim 1, wherein said tree data structure comprises:
an xtree structure representing a syntactic structure, wherein said xtree structure comprises a maximal projection node, at least one of an intermediate projection node, and
a head node;
pointers; and
properties for said tree data structure.

14. The method of claim 13, wherein each said node of said xtree structure is associated with at least one of a label representing the node position in said xtree data structure, a link to said tree data structure to which said tree node belongs, and morphological properties of a word.

15. The method of claim 1, wherein said tree data structure comprises a trace to another part, wherein said trace to another part is represented by having a maximal projection node.

16. The method of claim 1, wherein operations performed on said tree data structure comprises at least one of initializing with a pattern, substitution of a tree, adjunction of a tree, detachment and movement of a sub-tree from one location to another using one or more movement rules, leaf traversal and application of a function with accumulation of result.

17. The method of claim 1, wherein a tree rule is defined using at least one of an edge pattern in said graph data structure, two node patterns in said graph data structure, an output pattern in said tree data structure, and an output variable in said tree data structure.

18. The method of claim 1, wherein tree rules are applied by traversing said graph data structure in an order of edge types, and checking each said edge against a list of patterns of all possible graph-to-tree rules.

19. The method of claim 18, wherein a tree rule check is performed between corresponding entry nodes of the sub-graph, when a sub-graph is encountered.

20. The method of claim 1, wherein said tree rules pairwise coalesce tree and graphs in said graph data structure to create said tree data structure that comprise all the sub-trees in various substitution and adjunction positions.

21. The method of claim 20, wherein said sentence is defined as a top-most tree represented as xtree whose maximal projection node is of type Conjunction.

22. The method of claim 21, wherein said Conjunction xtree is followed by a sequence of xtrees whose maximal projection are of type Inflection which end in an xtree whose maximal projection is of type Verb, wherein head node of the said Verb xtree is a main verb of the sentence.

23. The method of claim 21, wherein said Conjunction xtree is created for a full sentence by:
searching for a pattern in said tree data structure, wherein said pattern is in given chain within the tree data structure, which matches given constraints on the pattern;
performing a tree transformation operation on said sentence; and
appending a terminal punctuation to said sentence.

24. The method of claim 23, wherein performing said tree transformation pattern operation on said sentence comprises at least one of:
performing no operation;
moving a node from one location to another location of said sub-tree;
creating said Conjunction xtree with given template.

25. The method of claim 16, wherein a movement rule comprises pattern to find source of movement, pattern to find destination of movement, and operation to be performed if both source and destination patterns are found.

26. The method of claim 25, wherein operation to be performed if both source and destination patterns are found is one of
movement of sub-tree to a given vacant node;
movement of head to a given head node;
copying properties from one tree structure to another;
setting properties on given tree structure;
removal of sub-tree; and
changing the word of a sub-tree.

27. The method of claim 1, wherein transforming, by said sequence converter, said tree data structure into a sentence of said target language comprises:
generating a sequence of words representing said sentence based on said tree data structure, wherein said sequence of words is generated by in-order traversal of the leaves of said tree data structure; and
converting said sequence of words into a sentence of said target language using said at least one sequence transformation rule, wherein said sequence transformation rule operates on a list of words excluding punctuation marks.

28. The method of claim 1, wherein said sequence transformation rule comprises pattern to search, and one or more output operations, wherein said pattern to search consists of a regular expression matching at least one element of the sequence, and wherein output operation is at least one of substitution of a word or set of words in the sequence by another word, deletion of a word or set of words in the sequence, addition of at least one word to the sequence, and rearrangement of words in the sequence, when said natural language is English.

29. An apparatus for natural language communication, said system comprising:
a computer readable medium having program modules to enable a method for language generation from a semantic interlingua, said program modules comprising:
a rule engine configured to provide plurality of rules;
a control module for
for generating a graph data structure of a semantic interlingua using at least one graph rule applied by a rule engine, and
generating a tree data structure based on an analysis of said graph data structure, wherein said graph data structure is analyzed based on at least one tree rule applied by the rule engine;
a sequence converter for
transforming said tree data structure into a sentence of target language, wherein said tree data structure is transformed based on at least one sequence transformation rule applied by the rule engine; and
a user interface module for
communicating said sentence in one of audio, visual, or audio-visual format.

30. The apparatus in claim 29, wherein said graph data structure comprises a plurality of graph nodes indicating at least one of a word-sense with annotations, a set of attributes, a special identifier indicating a sub-graph, and a list of edges.

31. The apparatus in claim 30, wherein each said graph node is associated with a dictionary, wherein said dictionary comprises at least one of root form of said word sense, morphological properties, parts of speech, semantic attributes, and framing structure.

32. The apparatus in claim 30, wherein said plurality of nodes comprises an entry node representing an entry-point for parsing said sentence.

33. The apparatus in claim 29, wherein said tree data structure comprises:
an xtree structure representing a syntactic structure, wherein said xtree structure comprises a maximal projection node, at least one of an intermediate projection node, and
a head node;
pointers; and
properties for said tree data structure.

34. The apparatus in claim 33, wherein each said node of said xtree structure is associated with at least one of a label representing the node position in said xtree data structure, a link to said tree data structure to which said tree node belongs, and morphological properties of a word.

35. The apparatus in claim 29, wherein said tree data structure comprises a trace to another part, wherein said trace to another part is represented by having a maximal projection node.

36. The apparatus in claim 29, wherein a sentence is defined as a top-most tree represented as xtree whose maximal projection node is of type Conjunction.

37. The apparatus in claim 36, wherein said Conjunction xtree is followed by a sequence of xtrees whose maximal projection are of type Inflection which end in an xtree whose maximal projection is of type Verb, wherein head node of the said Verb xtree is a main verb of the sentence.

38. The apparatus in claim 29, wherein a movement rule from among said plurality of rules comprises pattern to find source of movement, pattern to find destination of movement, and operation to be performed if both source and destination patterns are found.

39. The apparatus in claim 38, wherein pattern of said movement rule comprises tree structure template with at least one constraint on tree type, tree contents and tree attributes.

40. The apparatus in claim 29, wherein said sequence transformation rule comprises pattern to search, and one or more output operations, wherein said pattern to search consists of a regular expression matching at least one element of the sequence, and wherein output operation is at least one of substitution of a word or set of words in the sequence by another word, deletion of a word or set of words in the sequence, addition of at least one word to the sequence, and rearrangement of words in the sequence, when said natural language is English.
